(19) United States
(12) Patent Application Publication
(10) Pub. No.: US 2025/0155911 A1
(43) Pub. Date: May 15, 2025

(54) VOLTAGE REGULATORS

(71) Applicant: SAMSUNG ELECTRONICS CO., LTD., Suwon-si (KR)

(72) Inventors: Chaekang Lim, Suwon-si (KR); Youngwoo Park, Suwon-si (KR); Seungjin Park, Suwon-si (KR); Jindo Byun, Suwon-si (KR); Seunghoon Lee, Suwon-si (KR); Youngdon Choi, Suwon-si (KR)

(21) Appl. No.: 18/756,948

(22) Filed: Jun. 27, 2024

(30) Foreign Application Priority Data
Nov. 10, 2023 (KR) 10-2023-0155620

(51) Int. Cl. G05F 1/575

(52) U.S. Cl. CPC G05F 1/575

(57) ABSTRACT

A voltage regulator includes a pass transistor generating an output voltage in response to a gate voltage, and an error amplifier circuit outputting the gate voltage. The error amplifier circuit includes a first input terminal receiving a first reference voltage level from a reference voltage generator, a second input terminal receiving a second reference voltage level from the reference voltage generator, a third input terminal receiving a first voltage level of a first end of a target circuit, a fourth input terminal receiving a second voltage level of a second end of the target circuit, and an output terminal that outputs the gate voltage generated based on the first reference voltage level, the second reference voltage level, the first voltage level, and the second voltage level. A potential difference of the first voltage level and the second voltage level is an operating voltage of the target circuit.

### CROSS-REFERENCE TO RELATED APPLICATION

This application claims priority under 35 U.S.C. § 119 to Korean Patent Application No. 10-2023-0155620, filed on Nov. 10, 2023, in the Korean Intellectual Property Office, the disclosure of which is incorporated by reference herein in its entirety.

### BACKGROUND

A power management integrated circuit (PMIC) may generate a supply voltage to provide a power to electronic components. The level of the supply voltage may be determined based on the required performance of each electronic component. The power management integrated circuit may include a regulator for generating various levels of supply powers. The regulator refers to a circuit which converts a power input from the outside into a direct current power required by the system by using power switches. The regulator may include a DC-DC converter for stepping up or stepping down the input DC power as a power regulator. The regulator may be classified as a linear regulator or a switch regulator depending on its method of operation.

### SUMMARY

For purposes of this disclosure, it has been recognized that an operation of comparing an operating voltage provided to a load device and an input voltage provided to a regulator may be useful in generating a target operating voltage. A conventional voltage regulator fails to accurately detect the operating voltage provided to the load device, thereby causing a reduction in efficiency of the regulator.

Some aspects of the present disclosure provide a voltage regulator capable of controlling an output voltage, which is based on an operating voltage of a load device, more finely by accurately detecting the operating voltage provided to the load device.

According to some implementations, a voltage regulator includes a pass transistor that generates an output voltage in response to a gate voltage, and an error amplifier circuit that outputs the gate voltage. The error amplifier circuit includes a first input terminal that receives a first reference voltage level from a reference voltage generator, a second input terminal that receives a second reference voltage level from the reference voltage generator, a third input terminal that receives a first voltage level of a first end of a target circuit, a fourth input terminal that receives a second voltage level of a second end of the target circuit, and an output terminal that outputs the gate voltage generated based on the first reference voltage level, the second reference voltage level, the first voltage level, and the second voltage level. A potential difference of the first voltage level and the second voltage level is an operating voltage of the target circuit.

According to some implementations, a voltage regulator configured to generate an output voltage includes an error amplifier circuit that generates a gate voltage based on a first reference voltage level, a second reference voltage level, a first voltage level of a first end of a target circuit, and a second voltage level of a second end of the target circuit, and a pass transistor that generates the output voltage in response to the gate voltage. The first end is connected to the pass transistor through a line, a potential difference of the first reference voltage level and the second reference voltage level corresponds to a reference voltage, and a potential difference of the first voltage level and the second voltage level corresponds to an operating voltage of the target circuit.

According to some implementations, an electronic system includes electronic devices, and a power management integrated circuit that includes a voltage regulator configured to provide an output voltage to the electronic devices. The voltage regulator includes an error amplifier circuit that generates a gate voltage based on a first voltage level of a first node connected to a first end of a target circuit included in each of the electronic devices, the first end of the target circuit being provided with an operating current, a second voltage level of a second node connected to a second end of the target circuit, a first reference voltage level, and a second reference voltage level.

### BRIEF DESCRIPTION OF THE FIGURES

The above and other objects and features of the present disclosure will become apparent by describing in detail examples thereof with reference to the accompanying drawings.

FIG. 1 is a block diagram illustrating a voltage regulator, according to some implementations of the present disclosure.

FIG. 2 is a block diagram illustrating a voltage regulator, according to some implementations of the present disclosure.

FIG. 3 is a circuit diagram illustrating an example of the error amplifier circuit of FIG. 2 in detail, according to some implementations of the present disclosure.

FIG. 4 is a graph illustrating a gain of a second voltage of a voltage regulator relative to a reference voltage, according to some implementations of the present disclosure.

FIG. 5 is a flowchart illustrating an operating method of a voltage regulator, according to some implementations of the present disclosure.

FIG. 6 is a block diagram illustrating a voltage regulator, according to some implementations of the present disclosure.

FIG. 7 is a block diagram illustrating a voltage regulator, according to some implementations of the present disclosure.

FIG. 8 is a block diagram illustrating a voltage regulator, according to some implementations of the present disclosure.

FIG. 9 is a block diagram illustrating a voltage regulator, according to some implementations of the present disclosure.

FIG. 10 is a block diagram illustrating an electronic system, according to some implementations of the present disclosure.

FIG. 11 is a block diagram illustrating an electronic system, according to some implementations of the present disclosure.

FIG. 12 is a block diagram illustrating an electronic system, according to some implementations of the present disclosure.

### DETAILED DESCRIPTION

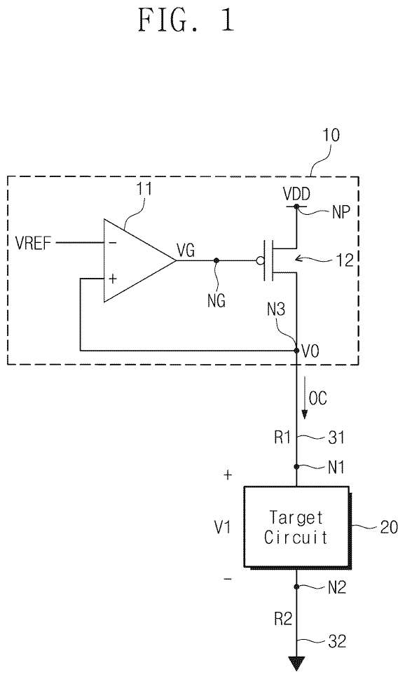

FIG. 1 is a block diagram illustrating a voltage regulator. Referring to FIG. 1, a voltage regulator 10 may include an error amplifier circuit 11 and a pass transistor 12 and may provide a voltage and a current to a target circuit 20.

The error amplifier circuit 11 may compare a reference voltage VREF and an output voltage VO and may generate a gate voltage VG based on a comparison result. In some implementations, the error amplifier circuit 11 may include an operational amplifier (OP-AMP). For example, the error amplifier circuit 11 may include an operational amplifier which receives the reference voltage VREF as an inverting input, receives the output voltage VO as a non-inverting input, and amplifies a difference between the reference voltage VREF and the output voltage VO to generate the gate voltage VG.

The reference voltage VREF may be a reference voltage which is provided from various reference voltage generators. In some implementations, the reference voltage VREF may be a voltage which is provided from a reference voltage generator placed outside the voltage regulator 10. For example, the reference voltage VREF may be a voltage which is provided from a bandgap reference voltage generator placed inside or outside the voltage regulator 10.

The pass transistor 12 may generate the output voltage VO and an output current (e.g., an operating current of the target circuit 20) of the voltage regulator 10 in response to the gate voltage VG. For example, the output voltage VO may be a potential difference between a ground node and a third node N3. The output current may be a load current OC, and the load current OC may be a current which is provided to the target circuit 20 through the third node N3. In some implementations, the pass transistor 12 may include a metal-oxide-semiconductor field-effect transistor (MOSFET) which operates in response to the gate voltage VG. For example, the pass transistor 12 may include a p-type MOSFET (hereinafter referred to as a “PMOS transistor”) which is connected between a power node NP and the third node N3 and operates in response to the gate voltage VG. In some implementations (e.g., as shown in FIGS. 1, 3, 6, and 8), when a FET as discussed herein is “connected between” a first node and a second node, the source or drain of the transistor is connected to the first node, and the other of the source or the drain is connected to the second node.

An example in which the error amplifier circuit 11 and a gate of the pass transistor 12 are directly connected through a gate node NG is illustrated in FIG. 1, but the present disclosure is not limited thereto. It should be understood that implementations in which a semiconductor element, a semiconductor circuit, or an electronic circuit is further included between the error amplifier circuit 11 and the pass transistor 12 are within the scope of this disclosure. For example, a buffer may be included between the error amplifier circuit 11 and the pass transistor 12.

The target circuit 20 may be connected to the pass transistor 12 through a first line 31 and may be connected to the ground node through a second line 32. The target circuit 20 may be provided with the power from the voltage regulator 10. For example, the target circuit 20 may be an electronic circuit, a load circuit, a semiconductor circuit, etc. which is included in a load device, a semiconductor device, or an electronic device.

The first line 31 may connect the third node N3 and the target circuit 20. For example, the first line 31 may connect the third node N3 and a first node N1 to which the target circuit 20 is connected. In some implementations, a first magnitude R1 of a resistance component of the first line 31 may increase or decrease depending on the degree of separation between the voltage regulator 10 and the target circuit 20. For example, as the separation distance between the voltage regulator 10 and the target circuit 20 increases, the first magnitude R1 may increase. A resistance component of the line between the voltage regulator 10 and the target circuit 20 is described as an example, but it should be understood that the resistance component of the first line 31 can include one or more other resistance components including a parasitic resistance component between the third node N3 and the target circuit 20, as well as a line resistance.

The second line 32 may connect the ground node and the target circuit 20. For example, the second line 32 may connect the ground node and a second node N2 to which the target circuit 20 is connected. In some implementations, a second magnitude R2 of a resistance component of the second line 32 may increase or decrease depending on the degree of separation between the ground node and the target circuit 20. For example, as the separation distance between the ground node and the target circuit 20 increases, the second magnitude R2 may increase. A resistance component of the line between the ground node and the target circuit 20 is described as an example, but it should be understood that the resistance component of the second line 32 can include one or more other resistance components including a parasitic resistance component between the ground node and the target circuit 20, as well as a line resistance.

Referring to FIG. 1, a first voltage V1 may be a voltage across opposite ends of the target circuit 20. In some implementations, the first voltage V1 may be an operating voltage of the target circuit 20. The first voltage V1 may be smaller than the output voltage VO due to the resistance component of the first line 31 and the resistance component of the second line 32. For example the first voltage V1 may correspond to a voltage obtained by subtracting a voltage dropped by the first line 31 and the second line 32 from the output voltage VO.

For example, the output voltage VO which the error amplifier circuit 11 receives may be different from the first voltage V1 that is the operating voltage of the target circuit 20. The voltage regulator 10 of FIG. 1 may fail to precisely control the operating voltage of the target circuit 20 (e.g., the first voltage V1). Accordingly, according to some implementations of the present disclosure, structures, devices, and operations capable of accurately detecting the first voltage V1 provided to the target circuit 20 so as to be provided to the error amplifier circuit 11 will be described in detail with reference to the following drawings.

Below, for convenience, description will be given with respect to an implementation of a voltage regulator 100 that is a low dropout regulator, but the present disclosure is not limited thereto. It should be understood that the structures, devices, systems, operations, and processes described herein (e.g., for accurately detecting a voltage of the target circuit 20) may be applicable to various semiconductor elements, semiconductor circuits, semiconductor devices, or electronic devices which may benefit from the accurate detection of the voltage of the target circuit 20.

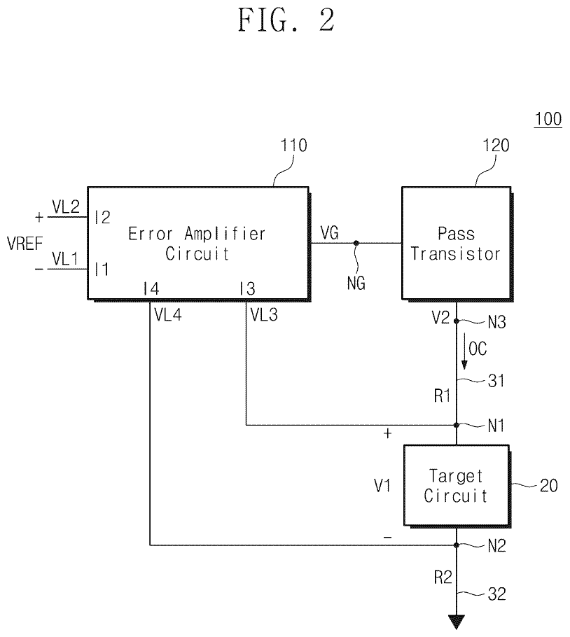

FIG. 2 is a block diagram illustrating a voltage regulator 100, according to some implementations of the present disclosure. Referring to FIG. 2, the voltage regulator 100 may include an error amplifier circuit 110 and a pass transistor 120 and may provide an output voltage and an output current to the target circuit 20. For example, the output voltage may be the first voltage V1, and the output current may be the load current OC. The target circuit 20 may be connected to the pass transistor 120 through the first line 31 and may be connected to the ground node through the second line 32. The first line 31 and the second line 32 may respectively correspond to the first line 31 and the second line 32 of FIG. 1. According to some implementations of the present disclosure, the voltage regulator 100 is capable of accurately detecting a voltage provided to the target circuit 20 and finely controlling the voltage.

The error amplifier circuit 110 may include four input terminals I1 to I4 and one output terminal. In some implementations, two input terminals among the four input terminals I1 to I4 of the error amplifier circuit 110 may be connected to opposite ends of the target circuit 20. For example, referring to FIG. 2, the third input terminal I3 of the error amplifier circuit 110 may be connected to the first node N1 where the target circuit 20 and the first line 31 are connected, and the fourth input terminal I4 of the error amplifier circuit 110 may be connected to the second node N2 where the target circuit 20 and the second line 32 are connected. In some implementations, the remaining two input terminals among the four input terminals I1 to I4 of the error amplifier circuit 110 may be connected to a reference voltage generator. For example, the first input terminal I1 of the error amplifier circuit 110 may be connected to a first output terminal of the reference voltage generator, and the second input terminal I2 of the error amplifier circuit 110 may be connected to a second output terminal of the reference voltage generator. The output terminal of the error amplifier circuit 110 may be connected to the pass transistor 120. For example, the error amplifier circuit 110 may be connected to the pass transistor 120 through the gate node NG. The error amplifier circuit 110 may provide the gate voltage VG to the pass transistor 120 through the gate node NG.

The error amplifier circuit 110 may be provided with four input voltage levels VL1 to VL4 respectively corresponding to the input terminals I1 to I4 through the input terminals I1 to I4. For example, the error amplifier circuit 110 may receive the first input voltage level VL1 through the first input terminal I1 and may receive the fourth input voltage level VL4 through the fourth input terminal I4. The above correspondence relationship between the four input terminals I1 to I4 and the four input voltage levels VL1 to VL4 is provided as an example, and the present disclosure is not limited thereto.

In some implementations, two of the four input voltage levels VL1 to VL4 of the error amplifier circuit 110 may be associated with a reference voltage. For example, the first input voltage level VL1 which the error amplifier circuit 110 receives may be a first reference voltage level, and the second input voltage level VL2 which the error amplifier circuit 110 receives may be a second reference voltage level. Herein, a potential difference between the first reference voltage level and the second reference voltage level may correspond to the reference voltage VREF. In some implementations, the first reference voltage level and the second reference voltage level may be provided from the reference voltage generator. An example in which the second input voltage level VL2 has a higher potential is illustrated in FIG. 2, but the present disclosure is not limited thereto. For example, it should be understood that implementations in which the first input voltage level VL1 has a higher potential also are within the scope of this disclosure.

In some implementations, two of the four input voltage levels VL1 to VL4 of the error amplifier circuit 110 may be associated with the first voltage V1, which can be the operating voltage of the target circuit 20. For example, the third input voltage level VL3 of the error amplifier circuit 110 may be a voltage level of the first node N1 where the target circuit 20 is connected to the first line 31, and the fourth input voltage level VL4 of the error amplifier circuit 110 may be a voltage level of the second node N2 where the target circuit 20 is connected to the second line 32. A potential difference between the third input voltage level VL3 and the fourth input voltage level VL4 may correspond to the first voltage V1, the operating voltage of the target circuit 20. The above input voltage levels VL1 to VL4 are described as an example, and the present disclosure is not limited thereto. For example, it should be understood that implementations in which a voltage is formed by any combination of the input voltage levels VL1 to VL4 are within the scope of this disclosure.

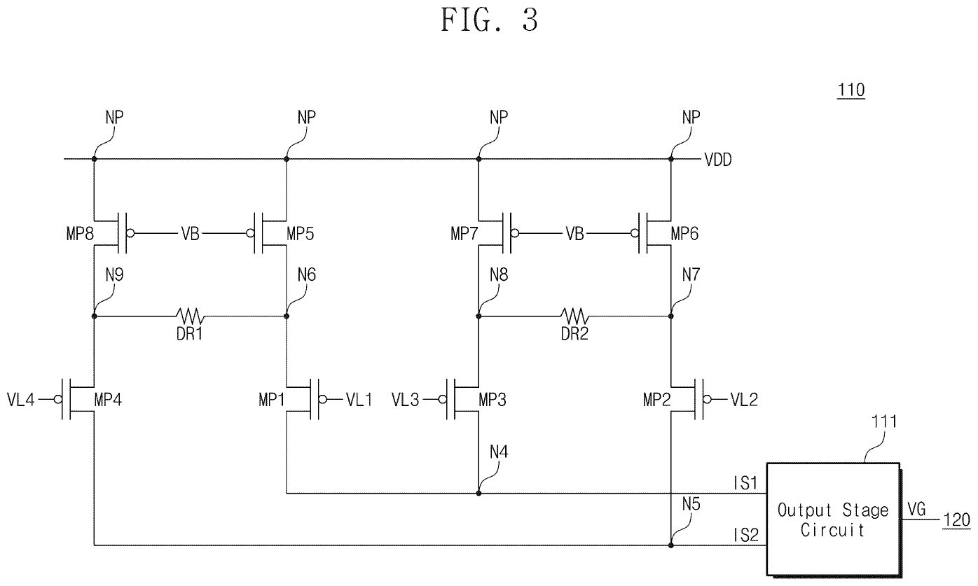

The error amplifier circuit 110 may generate the gate voltage VG based on the four input voltage levels VL1 to VL4. For example, the error amplifier circuit 110 may generate the gate voltage VG by comparing the reference voltage VREF formed by the first input voltage level VL1 and the second input voltage level VL2 and the first voltage V1 formed by the third input voltage level VL3 and the fourth input voltage level VL4 and amplifying a comparison result. An example of generation of the gate voltage VG based on the four input voltage levels VL1 to VL4 is described in detail with reference to FIG. 3.

The error amplifier circuit 110 may include a semiconductor circuit, a semiconductor device, an electronic circuit, or an electronic device configured to perform the above operations. In some implementations, the error amplifier circuit 110 may include an electronic circuit which receives four inputs and generates one output. For example, the error amplifier circuit 110 may include a differential difference amplifier (DDA) circuit which generates the gate voltage VG by comparing a signal obtained by summing the first reference voltage level and the voltage level of the first node N1 and a signal obtained by summing the second reference voltage level and the voltage level of the second node N2 and amplifying a comparison result. As another example, the error amplifier circuit 110 may include a voltage summer circuit which performs the same operations as described above. It should be understood that various implementation of the error amplifier circuit 110 which perform the above operations, for example, receive four input voltage levels and generate a gate voltage, are within the scope of this disclosure. An example of a structure and operations of the error amplifier circuit 110 will be described in detail with reference to FIG. 3.

The pass transistor 120 may generate the output voltage or the output current in response to the gate voltage VG. For example, the pass transistor 120 may generate a second voltage V2 or the load current OC in response to the gate voltage VG. In some implementations, the pass transistor 120 may include a MOSFET which operates in response to the gate voltage VG and generates the output voltage or the output current to be provided to the third node N3. For example, the pass transistor 120 may include a PMOS transistor which operates in response to the gate voltage VG and is connected to the third node N3 to generate the second voltage V2 or the load current OC. The above description is provided as an example, and it should be understood that various electronic circuits and/or electronic element capable of generating the second voltage V2 or the load current OC in response to the gate voltage VG may be included in, with, or instead of, the pass transistor 120.

The pass transistor 120 is illustrated as being directly connected to the error amplifier circuit 110 through the gate node NG, but the present disclosure is not limited thereto. For example, it may be understood that implementations in which a semiconductor element, a semiconductor circuit, or an electronic circuit is added between the pass transistor 120 and the error amplifier circuit 110 are within the scope of this disclosure. For example, a buffer circuit which buffers the output of the error amplifier circuit 110 to generate the gate voltage VG may be included between the pass transistor 120 and the error amplifier circuit 110.

FIG. 3 is a circuit diagram illustrating an example of the error amplifier circuit 110 of FIG. 2 in detail, according to some implementations of the present disclosure. Referring to FIG. 3, the error amplifier circuit 110 may include an output stage circuit 111, first to eighth MOSFETs MP1 to MP8, a first degeneration resistor DR1, and a second degeneration resistor DR2. An example in which the error amplifier circuit 110 generates the gate voltage VG based on the four input voltage levels VL1 to VL4 will be described with reference to FIG. 3.

Referring to FIG. 3, the first MOSFET MP1 may operate in response to the first input voltage level VL1 and may be connected between a fourth node N4 and a sixth node N6. The second MOSFET MP2 may operate in response to the second input voltage level VL2 and may be connected between a fifth node N5 and a seventh node N7. The third MOSFET MP3 may operate in response to the third input voltage level VL3 and may be connected between the fourth node N4 and an eighth node N8. The fourth MOSFET MP4 may operate in response to the fourth input voltage level VL4 and may be connected between the fifth node N5 and a ninth node N9.

The fifth MOSFET MP5 may operate in response to a bias voltage VB and may be connected between the sixth node N6 and the power node NP. The sixth MOSFET MP6 may operate in response to bias voltage VB and may be connected between the seventh node N7 and the power node NP. The seventh MOSFET MP7 may operate in response to the bias voltage VB and may be connected between the eighth node N8 and the power node NP. The eighth MOSFET MP8 may operate in response to the bias voltage VB and may be connected between the ninth node N9 and the power node NP. In some implementations, the bias voltage VB may be a voltage which is provided for operations of the fifth to eighth MOSFETs MP5 to MP8. In some implementations, all the first to eighth MOSFETs MP1 to MP8 may be implemented with an PMOS transistor, but the present disclosure is not limited thereto.

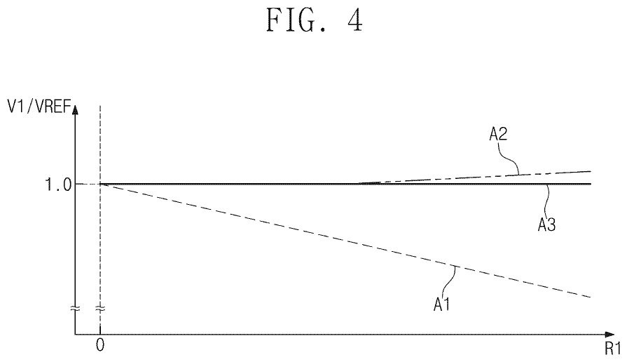

The first degeneration resistor DR1 may be connected between the sixth node N6 and the ninth node N9, and the second degeneration resistor DR2 may be connected between the seventh node N7 and the eighth node N8. In some implementations, a resistance magnitude of the first degeneration resistor DR1 may be identical to a resistance magnitude of the second degeneration resistor DR2. The above description is provided as an example, and it should be understood that examples of the error amplifier circuit 110 not including the first degeneration resistor DR1 or the second degeneration resistor DR2 are within the scope of this disclosure. Also, it should be understood that examples in which the first degeneration resistor DR1 and the second degeneration resistor DR2 have different magnitudes are within the scope of this disclosure. The role of the first degeneration resistor DR1 and the second degeneration resistor DR2 will be described in detail with reference to FIG. 4.

The output stage circuit 111 may generate the gate voltage VG based on a first input signal IS1 and a second input signal IS2. The first input signal IS1 may be provided through the fourth node N4 and may be a signal generated based on a sum of the first input voltage level VL1 and the third input voltage level VL3. Likewise, the second input signal IS2 may be provided through the fifth node N5 and may be a signal generated based on a sum of the second input voltage level VL2 and the fourth input voltage level VL4.

The output stage circuit 111 may generate the gate voltage VG based on a comparison of the first input signal IS1 and the second input signal IS2. In some implementations, the method in which the output stage circuit 111 generates the gate voltage VG may change depending on the type of the pass transistor 120 of FIG. 2. For example, when the pass transistor 120 of FIG. 2 includes an NMOS transistor operating in response to the gate voltage VG, the output stage circuit 111 may generate the gate voltage VG by amplifying a signal obtained by subtracting the second input signal IS2 from the first input signal IS1. As another example, when the pass transistor 120 of FIG. 2 includes a PMOS transistor operating in response to the gate voltage VG, the output stage circuit 111 may generate the gate voltage VG by amplifying a signal obtained by subtracting the first input signal IS1 from the second input signal IS2.

The above structure of the error amplifier circuit 110 is illustrated in FIG. 3 as an example, and the present disclosure is not limited thereto. It should be understood that various implementations in which four voltage levels associated with the reference voltage VREF and the operating voltage of the target circuit 20 are received and the gate voltage VG is generated based on the comparison and amplification of the four voltage levels are within the scope of this disclosure.

The structure of the voltage regulator 100 according to some implementations of the present disclosure is described with reference to FIGS. 2 and 3. The voltage regulator 100 may accurately detect a voltage provided to the target circuit 20. That is, unlike the voltage regulator 10 of FIG. 1, which detects only the output voltage VO, the voltage regulator 100 may directly detect the first voltage V1 (e.g., the operating voltage of the target circuit 20); in this case, the voltage regulator 100 may detect the operating voltage of the target circuit 20 without contributions from the voltage drop by the first line 31 and the second line 32. The voltage regulator 100 of FIG. 2 may provide the first voltage V1, which, for example, can be identical to the reference voltage VREF, to the target circuit 20 as the operating voltage, based on the above operations. The voltage regulator 100 of FIG. 2 may provide the target circuit 20 with an operating voltage (e.g., the second voltage V1) and an operating current (e.g., the load current OC), which are more accurate and stable than that of the voltage regulator 10 of FIG. 1, based on the above operations.

FIG. 4 is a graph illustrating the first voltage V1, the operating voltage of the target circuit 20, relative to the reference voltage VREF of the voltage regulator 10 of FIG. 1 and the voltage regulator 100 of FIGS. 2 and 3, according to some implementations of the present disclosure. Referring to FIGS. 1, 2, and 4, the horizontal axis represents a magnitude of a resistance component of the first line 31, and the vertical axis represents a gain of the first voltage V1 relative to the reference voltage VREF.

Referring to FIG. 4, three gains A1 to A3 are illustrated. The first gain A1 may indicate the gain of the voltage regulator 10 of FIG. 1. The second gain A2 may indicate the gain of a modification of the voltage regulator 100 of FIGS. 2 and 3, which does not include the degeneration resistors DR1 and DR2 of FIG. 3. The third gain A3 may indicate the gain of the voltage regulator 100 of FIGS. 2 and 3, which includes the degeneration resistors DR1 and DR2 of FIG. 3.

As the first magnitude R1 of the resistance component of the first line 31 increases, the first gain A1 may linearly decrease. Referring to FIGS. 1 and 4 together, when the first magnitude R1 of the resistance component of the first line 31 increases, the voltage drop between the first node N1 and the third node N3 may increase; in this case, the magnitude of the first voltage V1 being the potential difference between the first node N1 and the second node N2 may decrease.

Even though the first magnitude R1 of the resistance component of the first line 31 increases, the second gain A2 and the third gain A3 may not decrease. For example, each of the second gain A2 and the third gain A3 may have a value (e.g., a magnitude) which is identical to 1.0 or is somewhat smaller than 1.0. The reason is that the voltage regulator 100 of FIG. 2 operates based on the first voltage V1 across the target circuit 20 and is capable of applying a change in the first voltage V1 to the process of generating the second voltage V2 (or the output voltage). Unlike the second gain A2, the third gain A3 shows a response characteristic with more reinforced (or improved) linearity (i.e., a characteristic where a condition that V1/VREF is 1.0 is well maintained compared to the second gain A2). The reason is that the linearity of the third gain A3 is improved compared to the second A2, by adding the degeneration resistor DR1 or DR2.

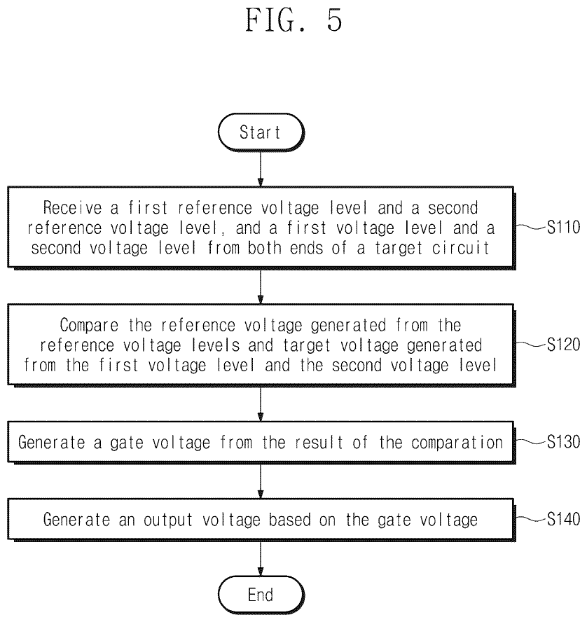

FIG. 5 is a flowchart illustrating an operating method of the voltage regulator 100 of FIG. 2, according to some implementations of the present disclosure. The operating method of the voltage regulator 100 will be described with reference to FIGS. 2 to 5.

In operation S110, the voltage regulator 100 may receive a first reference voltage level and a second reference voltage level and may receive a first voltage level and a second voltage level from opposite ends of the target circuit 20. For example, the voltage regulator 100 may receive the reference voltage levels of the reference voltage VREF, the first voltage level of the first node N1 connected to the target circuit 20, and the second voltage level of the second node N2 connected to the target circuit 20, through the error amplifier circuit 110.

In operation S120, the voltage regulator 100 may compare the reference voltage VREF generated from the first reference voltage level and the second reference voltage level and a target voltage generated from the first voltage level and the second voltage level of the opposite ends of the target circuit 20. For example, referring to FIGS. 2 and 5 together, the voltage regulator 100 may compare the reference voltage VREF generated from the first input voltage level VL1 and the second input voltage level VL2 and the operating voltage (or the first voltage V1) of the target circuit 20 corresponding to a potential difference between the third input voltage level VL3 and the fourth input voltage level VL4, through the error amplifier circuit 110.

In operation S130, the voltage regulator 100 may generate the gate voltage VG, based on a result of the comparison in operation S120. In some implementations, the voltage regulator 100 may generate the gate voltage VG by amplifying a difference between the operating voltage of the target circuit 20 and the reference voltage VREF. For example, the voltage regulator 100 may generate the gate voltage VG by amplifying a difference between the reference voltage VREF formed from the first input voltage level VL1 and the second input voltage level VL2 and the first voltage V1 formed from the third input voltage level VL3 and the fourth input voltage level VL4.

In operation S140, the voltage regulator 100 may generate the output voltage, based on the gate voltage VG. In some implementations, the voltage regulator 100 may generate the output voltage through the pass transistor 120 which operates in response to the gate voltage VG. For example, referring to FIGS. 2 and 5, the voltage regulator 100 may generate the output voltage (or the second voltage V2) through the third node N3 in response to the gate voltage VG.

An accurate operating voltage which can be beneficial for the target circuit 20 may be provided by accurately detecting a voltage between the opposite ends of the target circuit 20 and comparing the detected voltage with the reference voltage VREF, based on the above operation. Also, based on the above operation, in some implementations, the voltage regulator 100 may control the operating voltage (e.g., the first voltage V1) of the target circuit 20 more finely.

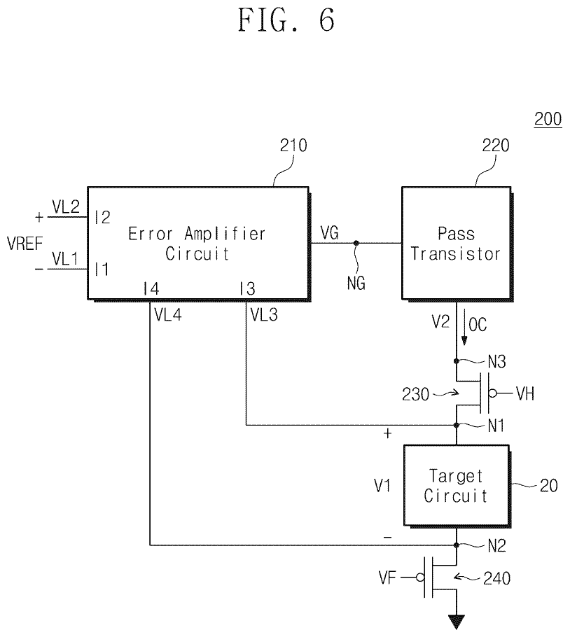

FIG. 6 is a block diagram illustrating a voltage regulator 200, according to some implementations of the present disclosure. Referring to FIG. 6, the voltage regulator 200 may include an error amplifier circuit 210, a pass transistor 220, a header transistor 230, and a footer transistor 240. The header transistor 230 may be connected between the target circuit 20 and the pass transistor 220. The footer transistor 240 may be connected between the target circuit 20 and the ground node. The target circuit 20 may be the same as or similar to the target circuit 20 of FIG. 2.

Like the error amplifier circuit 110 of FIG. 2, the error amplifier circuit 210 may include the four input terminals I1 to I4, two of the four input terminals I1 to I4 may be connected to a reference voltage generator, and the others thereof may be connected to the opposite ends of the target circuit 20. In some implementations, like the error amplifier circuit 110 of FIG. 2, the error amplifier circuit 210 may generate the gate voltage VG, based on the four input voltage levels VL1 to VL4.

Like the pass transistor 120 of FIG. 2, the pass transistor 220 may generate an output voltage or an output current in response to the gate voltage VG. For example, the pass transistor 220 may generate the first voltage V1 or the load current OC in response to the gate voltage VG. It should be understood that structures, configurations, and operations of the error amplifier circuit 210 and the pass transistor 220 of FIG. 6 are the same as or similar to those of the error amplifier circuit 110 and the pass transistor 120 of FIG. 2.

The header transistor 230 may operate in response to a header voltage VH (sometimes referred to as a “first power gating voltage”) and may be included between the target circuit 20 (or the first node N1) and the pass transistor 220 (or the third node N3). The header voltage VH may be a voltage for controlling the power gating. In some implementations, in response to the header voltage VH, the header transistor 230 may control an operation in which the output voltage or the load current OC of the pass transistor 220 is provided to the target circuit 20. For example, in response to the header voltage VH being a turn-off voltage, the header transistor 230 may block the output voltage or the load current OC of the pass transistor 220 from being provided to the target circuit 20.

In some implementations, an impedance component of the header transistor 230 may be included in a resistance component between the target circuit 20 and the third node N3 together with the resistance component of the first line 31 of FIGS. 1 and 2. For example, the impedance component of the header transistor 230 may be included in the resistance component between the target circuit 20 and the third node N3 together with the resistance component and any other parasitic resistance component of the first line 31.

The footer transistor 240 may operate in response to a footer voltage VF (sometimes referred to as a “second power gating voltage”) and may be connected between the target circuit 20 (or the second node N2) and the ground node. The footer voltage VF may be a voltage for controlling the power gating. In some implementations, the footer transistor 240 may block a leakage current of the target circuit 20 in response to the footer voltage VF. For example, the footer transistor 240 may block the leakage current of the target circuit 20 in response to the footer voltage VF being a turn-off voltage.

In some implementations, an impedance component of the footer transistor 240 may be included in a resistance component between the target circuit 20 and the ground node together with the resistance component of the second line 32 of FIGS. 1 and 2. For example, the impedance component of the footer transistor 240 may be included in the resistance component between the target circuit 20 and the ground node together with the resistance component and any other parasitic resistance component of the second line 32.

The voltage regulator 200 is illustrated in FIG. 6 as including both the header transistor 230 and the footer transistor 240. However, the present disclosure is not limited thereto. For example, it should be understood that the voltage regulator 200 not including at least one of the header transistor 230 or the footer transistor 240 is within the scope of this disclosure. Compared to the voltage regulator 100 of FIG. 2, through the header transistor 230 and/or the footer transistor 240, in some implementations, the voltage regulator 200 may efficiently control the supply of the power to the target circuit 20 or may efficiently block the leakage current of the target circuit 20.

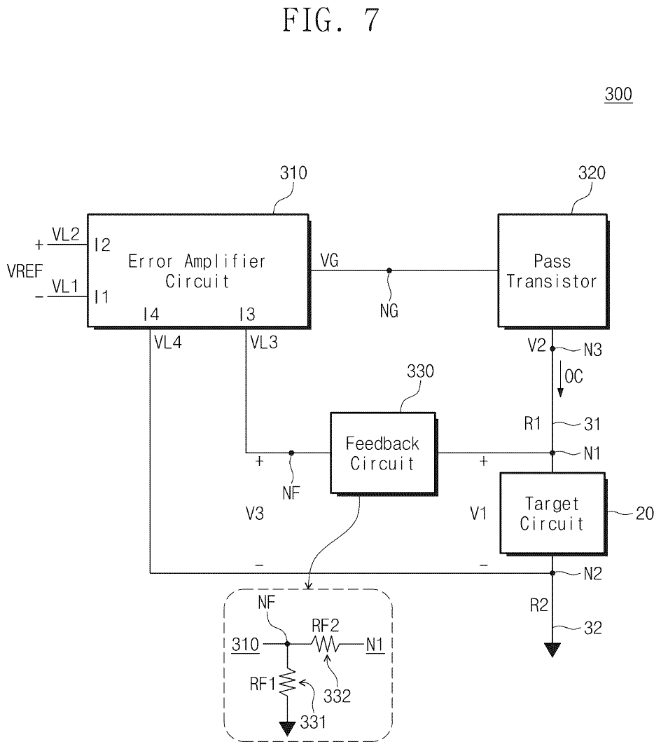

FIG. 7 is a block diagram illustrating a voltage regulator 300, according to some implementations of the present disclosure. Referring to FIG. 7, the voltage regulator 300 may include an error amplifier circuit 310, a pass transistor 320, and a feedback circuit 330. The target circuit 20 may be connected to the pass transistor 320 through the first line 31 and may be connected to the ground node through the second line 32. The first line 31 and the second line 32 may respectively correspond to the first line 31 and the second line 32 of FIG. 2. The target circuit 20 may be the same as or similar to the target circuit 20 of FIG. 2. In some implementations, the voltage regulator 300 is capable of providing the target circuit 20 with an operating voltage higher than the reference voltage VREF.

Like the error amplifier circuit 110 of FIG. 2, the error amplifier circuit 310 may include the four input terminals I1 to I4 and may be provided with the four input voltage levels VL1 to VL4 respectively corresponding to the four input terminals I1 to I4, through the four input terminals I1 to I4. In some implementations, two of the four input terminals I1 to I4 of the error amplifier circuit 310 may be connected to a reference voltage generator, one of the remaining input terminals thereof may be connected to the second node N2, and the other of the remaining input terminals thereof may be connected to the feedback circuit 330. For example, the first input terminal I1 and the second input terminal I2 of the error amplifier circuit 310 may be connected to the reference voltage generator, the third input terminal I3 may be connected to the feedback circuit 330, and the fourth input terminal I4 may be connected to the second node N2.

The error amplifier circuit 310 may generate the gate voltage VG based on the input voltage levels VL1 to VL4 received through the input terminals I1 to I4. For example, the error amplifier circuit 310 may receive a first reference voltage level corresponding to the first input voltage level VL1, a second reference voltage level corresponding to the second input voltage level VL2, a voltage level of a feedback node NF corresponding to the third input voltage level VL3, and a voltage level of the second node N2 corresponding to the fourth input voltage level VL4, and the feedback node NF may be connected to the feedback circuit 330. Like the error amplifier circuit 110 of FIG. 2, the error amplifier circuit 310 may generate the gate voltage VG, based on the first to fourth input voltage levels VL1 to VL4.

Like the pass transistor 120 of FIG. 2, the pass transistor 320 may generate an output voltage or an output current in response to the gate voltage VG. For example, the pass transistor 320 may generate the first voltage V1 or the load current OC in response to the gate voltage VG. It should be understood that structures, components, and operations of the error amplifier circuit 310 and the pass transistor 320 of FIG. 7 are the same as or similar to those of the error amplifier circuit 110 and the pass transistor 120 of FIG. 2.

The feedback circuit 330 may be connected between the first node N1 where the target circuit 20 and the first line 31 are connected and the error amplifier circuit 310 (or the feedback node NF). In some implementations, the feedback circuit 330 may provide the target circuit 20 with an operating voltage higher than the reference voltage VREF. For example, the feedback circuit 330 may make it possible to provide the target circuit 20 with the first voltage V1 higher than a third voltage V3 that is a potential difference between the feedback node NF and the second node N2. The third voltage V3 may be identical to the reference voltage VREF.

In some implementations, the feedback circuit 330 may include a circuit implemented with a plurality of resistors. For example, as shown in the inset drawing of FIG. 7, the feedback circuit 330 may include a first feedback resistor 331 which is connected between the ground node and the feedback node NF and has a resistance magnitude RF1, and a second feedback resistor 332 which is connected between the feedback node NF and the first node N1 and has a resistance magnitude RF2. The magnitude of the third voltage V3 which is provided to the target circuit 20 based on the operation of the feedback circuit 330 may be a voltage greater than a value obtained by multiplying the second voltage V2 (or the reference voltage VREF) and (1+RF2/RF1) together.

The voltage regulator 300 may provide the target circuit 20 with the first voltage V1, which is greater than the reference voltage VREF, as an operating voltage, based on the above operation. The above structure and operation of the feedback circuit 330 are provided as an example, and the present disclosure is not limited thereto. It should be understood that various examples of the feedback circuit 330 capable of providing the target circuit 20 with the first voltage V1 greater than the reference voltage VREF are within the scope of this disclosure.

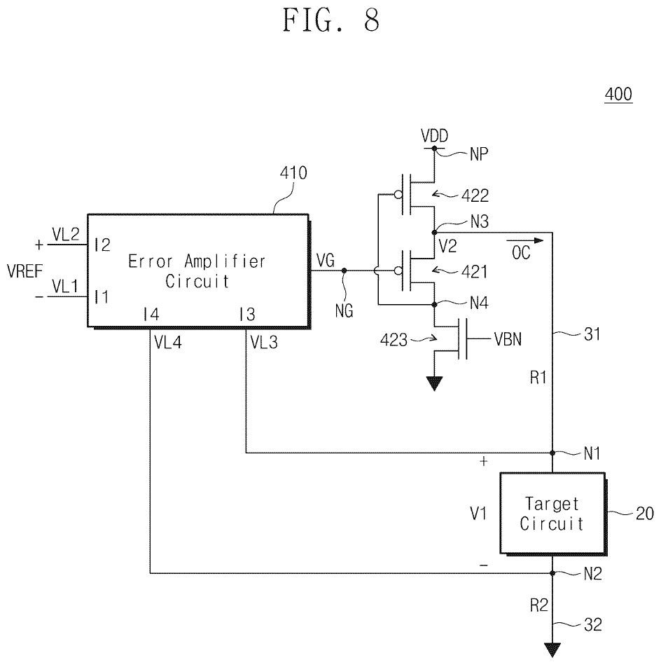

FIG. 8 is a block diagram illustrating a voltage regulator 400, according to some implementations of the present disclosure. Referring to FIG. 8, the voltage regulator 400 may include an error amplifier circuit 410, a first pass transistor 421, a second pass transistor 422, and a third pass transistor 423. The target circuit 20 may be connected to the third node N3 through the first line 31 and may be connected to the ground node through the second line 32. The first line 31 and the second line 32 may respectively correspond to the first line 31 and the second line 32 of FIG. 2. The target circuit 20 may be the same as or similar to the target circuit 20 of FIG. 2. According to some implementations of the present disclosure, the voltage regulator 400 is capable of providing a fast response.

Like the error amplifier circuit 110 of FIG. 2, the error amplifier circuit 410 may include the four input terminals I1 to I4, two of the four input terminals I1 to I4 may be connected to a reference voltage generator, and the others thereof may be connected to the opposite ends of the target circuit 20. In some implementations, like the error amplifier circuit 110 of FIG. 2, the error amplifier circuit 410 may generate the gate voltage VG, based on the four input voltage levels VL1 to VL4. It should be understood that a structure, a configuration, and an operation of the error amplifier circuit 410 of FIG. 8 are the same as or similar to those of the error amplifier circuit 110 of FIG. 2.

The first pass transistor 421 may operate in response to the gate voltage VG and may be connected between the third node N3 and the fourth node N4. For example, the first pass transistor may include a PMOS transistor which includes a gate connected to the gate node NG, that is, connected to the error amplifier circuit 410 through the gate node NG. The first pass transistor 421 is connected between the third node N3 and the fourth node N4. The second pass transistor 422 may include a gate connected to the fourth node N4 and may be connected between the third node N3 and the power node NP. For example, the second pass transistor 422 may include a PMOS transistor which includes a gate connected to the fourth node N4 and which is connected between the third node N3 and the power node NP.

The third pass transistor 423 may operate in response to a bias voltage VBN and may be connected between the fourth node N4 and the ground node. For example, the third pass transistor 423 may include an n-type MOSFET (hereinafter referred to as an “NMOS transistor”) which operates in response to the bias voltage VBN and which is connected between the fourth node N4 and the ground node. The above description given with reference to the first to third pass transistors 431 to 423 is provided as an example, and the present disclosure is not limited thereto.

The voltage regulator 400 may provide a fast response to changes in the first voltage V1 (e.g., the operating voltage of the target circuit 20), the voltage level of the third node N3, or the load current OC, based at least on the structure and configuration of the first to third pass transistors 431 to 423.

The error amplifier circuit 410 and the first pass transistor 421 are illustrated in FIG. 8 as being directly connected, but the present disclosure is not limited thereto. For example, it should be understood that a semiconductor element such as a buffer circuit, an electronic circuit, etc., can be additionally included between the error amplifier circuit 410 and the first pass transistor 421. The gate of the second pass transistor 422 is illustrated as being directly connected to the fourth node N4, but the present disclosure is not limited thereto. For example, it should be understood that implementations in which a buffer, an element such as an inductor or a filter, a semiconductor circuit, an electronic circuit, etc. is additionally included between the gate of the second pass transistor 422 and the fourth node N4 belong within the scope of this disclosure.

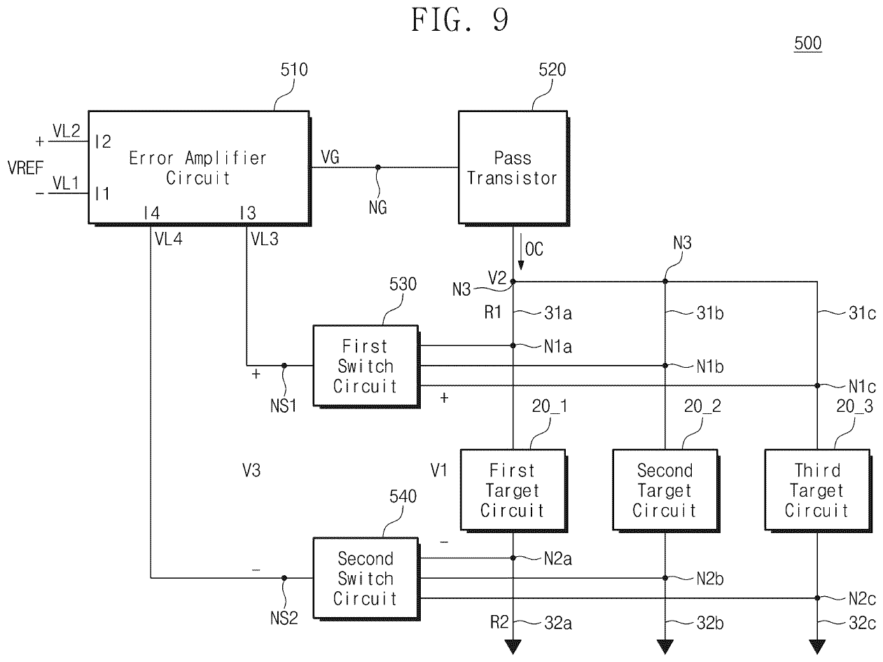

FIG. 9 is a block diagram illustrating a voltage regulator 500, according to some implementations of the present disclosure. Referring to FIG. 9, the voltage regulator 500 may include an error amplifier circuit 510, a pass transistor 520, a first switch circuit 530, and a second switch circuit 540. A first target circuit 20_1 may be connected to the pass transistor 520 through a 1a-th line 31a and may be connected to the ground node through a 2a-th line 32a. Likewise, a second target circuit 20_2 may be connected to the pass transistor 520 through a 1b-th line 31b and may be connected to the ground node through a 2b-th line 32b. A third target circuit 20_3 may be connected to the pass transistor 520 through a 1c-th line 31c and may be connected to the ground node through a 2c-th line 32c. The 1a-th to 1c-th lines 31a, 31b, and 31c may be collectively referred to as the “first line 31”, the 2a-th to 2c-th lines 32a, 32b, and 32c may be collectively referred to as the “second line 32”, and the first line 31 and the second line 32 may respectively correspond to the first line 31 and the second line 32 of FIG. 2.

Like the error amplifier circuit 110 of FIG. 2, the error amplifier circuit 510 may include the four input terminals I1 to I4 and may be provided with the four input voltage levels VL1 to VL4 respectively corresponding to the four input terminals I1 to I4, through the four input terminals I1 to I4. In some implementations, two of the four input terminals I1 to I4 of the error amplifier circuit 510 may be connected to a reference voltage generator, one of the remaining input terminals thereof may be connected to the first switch circuit 530, and the other of the remaining input terminals thereof may be connected to the second switch circuit 540. For example, the first input terminal I1 and the second input terminal I2 of the error amplifier circuit 510 may be connected to the reference voltage generator, the third input terminal I3 may be connected to the first switch circuit 530, and the fourth input terminal I4 may be connected to the second switch circuit 540.

The error amplifier circuit 510 may generate the gate voltage VG based on the input voltage levels VL1 to VL4 received through the input terminals I1 to I4. For example, the error amplifier circuit 510 may receive a first reference voltage level corresponding to the first input voltage level VL1, a second reference voltage level corresponding to the second input voltage level VL2, a voltage level of a first switch node NS1 corresponding to the third input voltage level VL3, and a voltage level of a second switch node NS2 corresponding to the fourth input voltage level VL4. The first switch node NS1 may be connected to first switch circuit 530, and the second switch node NS2 may be connected to the second switch circuit 540. Like the error amplifier circuit 110 of FIG. 2, the error amplifier circuit 510 may generate the gate voltage VG, based on the first to fourth input voltage levels VL1 to VL4.

Like the pass transistor 120 of FIG. 2, the pass transistor 520 may generate an output voltage or an output current in response to the gate voltage VG. For example, the pass transistor 520 may generate the first voltage V1 or the load current OC in response to the gate voltage VG. It should be understood that structures, configurations, and operations of the error amplifier circuit 510 and the pass transistor 520 of FIG. 9 are the same as or similar to those of the error amplifier circuit 110 and the pass transistor 120 of FIG. 2.

The first switch circuit 530 may be connected to the target circuits 20_1, 20_2, and 20_3 through first nodes N1a, N1b, and N1c and may be connected to the error amplifier circuit 510 through the first switch node NS1. In some implementations, voltage levels of the opposite ends of the first switch circuit 530 may be identical. For example, voltage levels of the first nodes N1a, N1b, and N1c may be identical to the voltage level of the first switch node NS1.

In some implementations, the first switch circuit 530 may allow the error amplifier circuit 510 and a first end of each of the target circuits 20_1, 20_2, and 20_3 to be connected or to be disconnected. For example, the first switch circuit 530 may include individual switches respectively connected between the first ends of the target circuits 20_1, 20_2, and 20_3 and the first switch node NS1, and may individually control the connection of the error amplifier circuit 510 with the first end of each of the target circuits 20_1, 20_2, and 20_3 by controlling the individual switches. In detail, for example, the first switch circuit 530 may control the connection between the error amplifier circuit 510 and the target circuits 20_1, 20_2, and 20_3 such that the first end of the first target circuit 201 (e.g., the 1a-th node N1a) and the first end of the second target circuit 202 (e.g., the 1b-th node N1b) are connected to the error amplifier circuit 510 and the first end of the third target circuit 20_3 (e.g., the 1c-th node N1c) is not connected to the error amplifier circuit 510. For another example, the first switch circuit 530 may include a multiplexer which selects one of the target circuits 20_1, 20_2, and 20_3 such that the first end of the selected target circuit is connected to the error amplifier circuit 510.

The second switch circuit 540 may be connected to the target circuits 20_1, 20_2, and 20_3 through second nodes N2a, N2b, and N2c and may be connected to the error amplifier circuit 510 through the second switch node NS2. In some implementations, voltage levels of the opposite ends of the second switch circuit 540 may be identical. For example, voltage levels of the second nodes N2a, N2b, and N2c may be identical to the voltage level of the second switch node NS2.

In some implementations, the second switch circuit 540 may allow the error amplifier circuit 510 and a second end of each of the target circuits 20_1, 20_2, and 20_3 to be connected or to be disconnected. For example, the second switch circuit 540 may include individual switches respectively connected between the second ends of the target circuits 20_1, 20_2, and 20_3 and the second switch node NS2, and may individually control the connection of the error amplifier circuit 510 with the second end of each of the target circuits 20_1, 20_2, and 20_3 by controlling the individual switches. In detail, for example, the second switch circuit 540 may control the connection between the error amplifier circuit 510 and the target circuits 20_1, 20_2, and 20_3 such that the second end of the first target circuit 201 (e.g., the 2a-th node N2a) and the second end of the second target circuit 20_2 (e.g., the 2b-th node N2b) are connected to the error amplifier circuit 510 and the second end of the third target circuit 203 (e.g., the 2c-th node N2c) is not connected to the error amplifier circuit 510. For another example, the second switch circuit 540 may include a multiplexer which selects one of the target circuits 20_1, 20_2, and 20_3 such that the second end of the selected target circuit is connected to the error amplifier circuit 510.

The target circuits 20_1, 20_2, and 20_3 which the first switch circuit 530 connects to the error amplifier circuit 510 may be identical to the target circuits 20_1, 20_2, and 20_3 which the second switch circuit 540 connects to the error amplifier circuit 510. For example, when the first switch circuit 530 allows the first end of the second target circuit 20_2 (e.g., the 1b-th node N1b) to be connected to the error amplifier circuit 510, the second switch circuit 540 may also allow the second end of the second target circuit 20_2 (e.g., the 2b-th node N2b) to be connected to the error amplifier circuit 510.

The voltage regulator 500 of FIG. 9 may provide the operating voltage or the operating current by selecting at least one or more of a plurality of target circuits based on the above process. The above structure and operation of the first switch circuit 530 or the second switch circuit 540 are provided as an example. Also, it should be understood that implementations of the voltage regulator 500 which do not include the second switch circuit 540 and in which the 2a-th node N2a, the 2b-th node N2b, and the 2c-th node N2c are integrated into one node are within the scope of this disclosure.

The voltage regulator 500 is illustrated in FIG. 9 as being connected to three target circuits 20_1, 20_2, and 20_3, but the present disclosure is not limited thereto. It may be understood that implementations in which a voltage regulator includes two target circuits or four or more target circuits and in which a voltage regulator includes the switch circuit 530 capable of controlling the connection between the error amplifier circuit 510 and each target circuit are within the scope of this disclosure.

The voltage regulators 100 to 500 according to various implementations of the present disclosure are described with reference to FIGS. 2 and 6 to 9. It may be understood that the scope of this disclosure includes arbitrary combinations two or more of the voltage regulators 100 to 500. For example, it should be understood that implementations can include any or all of power gating (refer to FIG. 6) a feedback circuit (refer to FIG. 7), pass transistors (refer to FIG. 8), and/or a plurality of target circuits and one or more switch circuits (refer to FIG. 9) are within the scope of this disclosure.

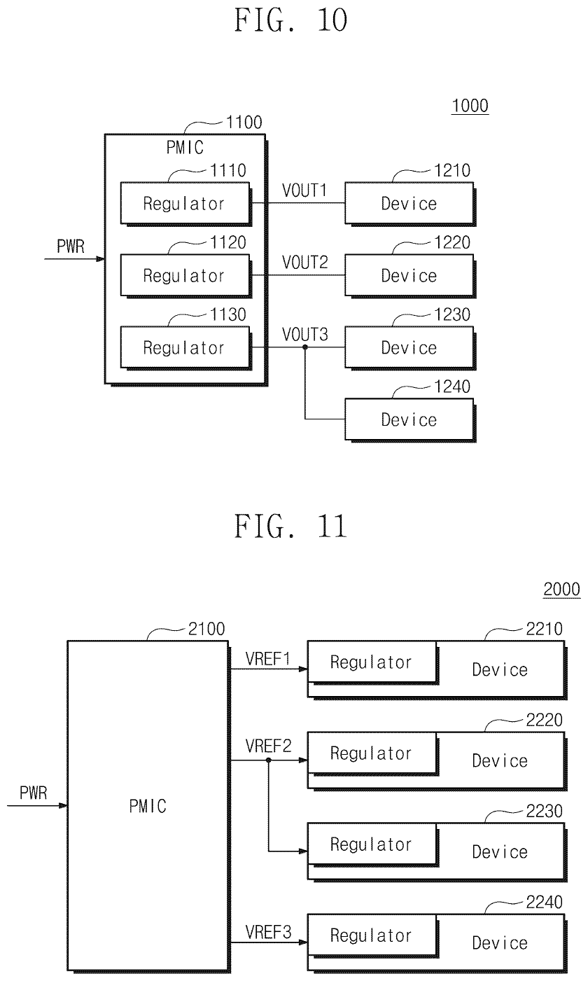

FIG. 10 is a block diagram illustrating an electronic system to which a voltage regulator according to implementations of the present disclosure can be applied. Referring to FIG. 10, an electronic system 1000 may include a power management integrated circuit (PMIC) 1100 and a plurality of devices 1210 to 1240. In some implementations, the electronic system 1000 may be one of various electronic devices such as a portable communication terminal, a personal digital assistant (PDA), a portable media player (PMP), a digital camera, a smartphone, a tablet computer, a laptop computer, and a wearable device. In some implementations, the electronic system 1000 may be implemented with a system-on-chip (SOC) or a system-on-package (SoP).

The power management integrated circuit 1100 may receive an external power PWR and may generate a plurality of output voltages VOUT1, VOUT2, and VOUT3 based on the external power PWR. For example, the power management integrated circuit 1100 may include a first voltage regulator 1110 configured to generate the first output voltage VOUT1, a second voltage regulator 1120 configured to generate the second output voltage VOUT2, and a third voltage regulator 1130 configured to generate the third output voltage VOUT3.

In some implementations, each of the first to third voltage regulators 1110 to 1130 may be any of the voltage regulators 100 to 500 described with reference to FIGS. 2 to 9 or a combination of two or more thereof, and/or may operate based on the operating method described with reference to FIGS. 2 to 9.

The plurality of devices 1210 to 1240 may include an electronic circuit, a logic circuit, or a memory circuit configured to support various operations of the electronic system 1000. For example, each of the devices 1210 to 1240 may include the target circuit 20 illustrated in FIGS. 2 to 9. The plurality of devices 1210 to 1240 may be provided with the power from the power management integrated circuit 1100 and may operate based on the provided power. For example, the first device 1210 may receive the first output voltage VOUT1 from the power management integrated circuit 1100 and may operate based on the first output voltage VOUT1. The second device 1220 may receive the second output voltage VOUT2 from the power management integrated circuit 1100 and may operate based on the second output voltage VOUT2. Each of the third device 1230 and the fourth device 1240 may receive the third output voltage VOUT3 from the power management integrated circuit 1100 and may operate based on the third output voltage VOUT3 (e.g., using a configuration as described with respect to FIG. 9).

In some implementations, the first to third output voltages VOUT1 to VOUT3 may have different values or may have the same value. For example, the first output voltage VOUT1 may be identical to the second output voltage VOUT2, and the first output voltage VOUT1 may be different from the third output voltage VOUT3. In this case, the voltage regulators 1110 to 1130 may respectively generate the first to third output voltages VOUT1, VOUT2, and VOUT3, based on the size (e.g., W/L) or a structure (e.g., a CS structure or a combination of CS and SF structures) of a pass transistor 160 or 260.

FIG. 11 is a block diagram illustrating an electronic system to which a voltage regulator according to implementations of the present disclosure can be applied. Referring to FIG. 11, an electronic system 2000 may include a power management integrated circuit (PMIC) 2100 and a plurality of devices 2110 to 2240. For example, each of the devices 2110 to 2140 may include the target circuit 20 of FIGS. 2 to 9.

The power management integrated circuit 2100 may generate a plurality of reference voltages VREF1 to VREF3 by using the external power PWR. For example, the power management integrated circuit 2100 may generate a plurality of reference voltages VREF1 to VREF3 by using a reference voltage generator.

The plurality of devices 2210 to 2240 may receive the plurality of reference voltages VREF1 to VREF3 from the power management integrated circuit 2100 and may generate operating voltages by using the reference voltages VREF1 to VREF3. For example, each of the plurality of devices 2210 to 2240 may include a voltage regulator. The voltage regulator of the first device 2210 may generate a first operating voltage to be used in the first device 2210, based on the first reference voltage VREF1. The voltage regulator of the second device 2220 may generate a second operating voltage to be used in the second device 2220, based on the second reference voltage VREF2. The voltage regulator of the third device 2230 may generate a third operating voltage to be used in the third device 2230 based on the second reference voltage VREF2. The voltage regulator of the fourth device 2240 may generate a fourth operating voltage to be used in the fourth device 2240 based on the third reference voltage VREF3.

In some implementations, the voltage regulators included in each of the plurality of devices 2210 to 2240 may be any of the voltage regulators described with reference to FIGS. 2 to 9 or may be a combination thereof.

In some implementations, operating voltages which are generated by using the same reference voltage may be identical to each other. For example, the second and third operating voltages generated by the voltage regulators of the second and third devices 2220 and 2230 by using the second reference voltage VREF2 may be identical to each other. Also, operating voltages which are generated by using the same reference voltage may have different levels. For example, the second and third operating voltages generated by the voltage regulators of the second and third devices 2220 and 2230 by using the second reference voltage VREF2 may be different from each other. This may be variously changed or modified depending on the way to implement a voltage regulator and a level of an operating voltage required by each device.

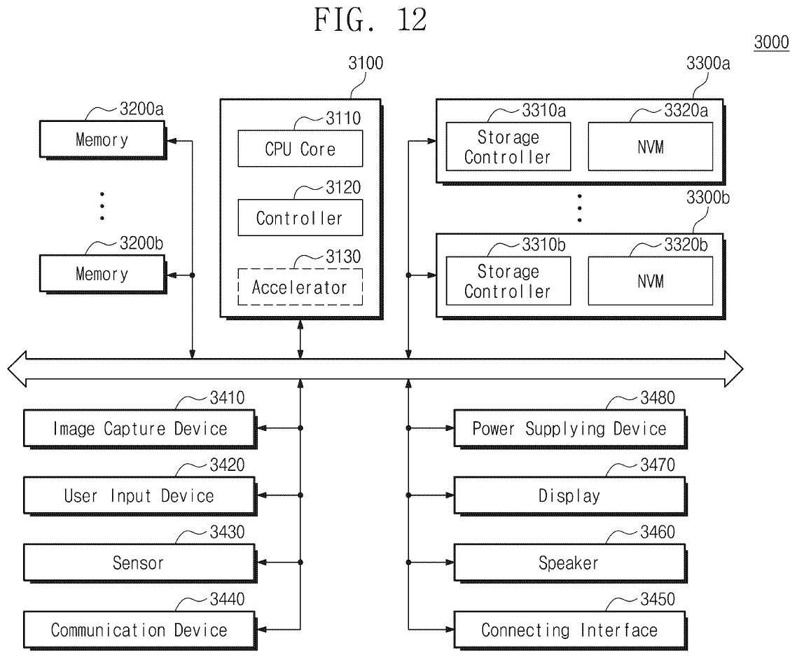

FIG. 12 is a diagram of a system 3000 to which a storage device is applied, according to some implementations. The system 3000 of FIG. 12 may be, for example, a mobile system, such as a portable communication terminal (e.g., a mobile phone), a smartphone, a tablet personal computer (PC), a wearable device, a healthcare device, or an Internet of things (IoT) device. However, the system 3000 of FIG. 12 is not necessarily limited to a mobile system and may be a PC, a laptop computer, a server, a media player, an automotive device (e.g., a navigation device), or another type of device.

Referring to FIG. 12, the system 3000 may include a main processor 3100, memories (e.g., 3200a and 3200b), and storage devices (e.g., 3300a and 3300b). In addition, the system 3000 may include at least one of an image capturing device 3410, a user input device 3420, a sensor 3430, a communication device 3440, a connecting interface 3450, a speaker 3460, a display 3470, and a power supplying device 3480.

The main processor 3100 may control all operations of the system 3000, more specifically, operations of other components included in the system 3000. The main processor 3100 may be implemented as a general-purpose processor, a dedicated processor, or an application processor.

The main processor 3100 may include at least one CPU core 3110 and further include a controller 3120 configured to control the memories 3200a and 3200b and/or the storage devices 3300a and 3300b. In some implementations, the main processor 3100 may further include an accelerator 3130, which is a dedicated circuit for a high-speed data operation, such as an artificial intelligence (AI) data operation. The accelerator 3130 may include a graphics processing unit (GPU), a neural processing unit (NPU) and/or a data processing unit (DPU) and be implemented as a chip that is physically separate from the other components of the main processor 3100.

The memories 3200a and 3200b may be used as main memory devices of the system 3000. Although each of the memories 3200a and 3200b may include a volatile memory, such as static random access memory (SRAM) and/or dynamic RAM (DRAM), each of the memories 3200a and 3200b may include non-volatile memory, such as a flash memory, phase-change RAM (PRAM) and/or resistive RAM (RRAM). The memories 3200a and 3200b may be implemented in the same package as the main processor 3100.

The storage devices 3300a and 3300b may serve as non-volatile storage devices configured to store data regardless of whether power is supplied thereto, and have larger storage capacity than the memories 3200a and 3200b. The storage devices 3300a and 3300b may respectively include storage controllers (STRG CTRL) 3310a and 3310b and NVM (Non-Volatile Memory)s 3320a and 3320b configured to store data via the control of the storage controllers 3310a and 3310b. Although the NVMs 3320a and 3320b may include flash memories having a two-dimensional (2D) structure or a three-dimensional (3D) V-NAND structure, the NVMs 3320a and 3320b may include other types of NVMs, such as PRAM and/or RRAM.

The storage devices 3300a and 3300b may be physically separated from the main processor 3100 and included in the system 3000 or implemented in the same package as the main processor 3100. In addition, the storage devices 3300a and 3300b may have types of solid-state devices (SSDs) or memory cards and be removably combined with other components of the 3000 100 through an interface, such as the connecting interface 3450 that will be described below. The storage devices 3300a and 3300b may be devices to which a standard protocol, such as a universal flash storage (UFS), an embedded multi-media card (eMMC), or a non-volatile memory express (NVMe), is applied, without being limited thereto.

The image capturing device 3410 may capture still images or moving images. The image capturing device 3410 may include a camera, a camcorder, and/or a webcam.

The user input device 3420 may receive various types of data input by a user of the system 3000 and include a touch pad, a keypad, a keyboard, a mouse, and/or a microphone.

The sensor 3430 may detect various types of physical quantities, which may be obtained from the outside of the system 3000, and convert the detected physical quantities into electric signals. The sensor 3430 may include a temperature sensor, a pressure sensor, an illuminance sensor, a position sensor, an acceleration sensor, a biosensor, and/or a gyroscope sensor.

The communication device 3440 may transmit and receive signals between other devices outside the system 3000 according to various communication protocols. The communication device 3440 may include an antenna, a transceiver, and/or a modem.

The connecting interface 3450 may provide connection between the system 3000 and an external device, which is connected to the system 3000 and capable of transmitting and receiving data to and from the system 3000. The connecting interface 3450 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

The speaker 3460 and the display 3470 may serve as output devices configured to respectively output auditory information and visual information to the user of the system 3000.

The power supplying device 3480 may appropriately convert the power from a battery embedded in the system 3000 and/or from an external power source, so as to be supplied to each component of the system 3000. In some implementations, the power supplying device 3480 may include a voltage regulator described with reference to FIGS. 2 to 11 and may be configured to generate various operation powers by using the voltage regulator.

According to implementations of the present disclosure, voltage regulators capable of finely controlling a voltage and/or a current to be provided to a load device, electronic systems including the same, and operating methods thereof are provided.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to examples thereof, it will be apparent to those of ordinary skill in the art that various changes and modifications may be made thereto without departing from the spirit and scope of the present disclosure as set forth in the following claims.

What is claimed is:

1. A voltage regulator comprising:
at least one pass transistor configured to generate an output voltage based on a gate voltage; and
an error amplifier circuit configured to output the gate voltage,
wherein the error amplifier circuit includes:
a first input terminal configured to receive a first reference voltage level from a reference voltage generator;
a second input terminal configured to receive a second reference voltage level from the reference voltage generator;
a third input terminal configured to receive a first voltage level of a first end of a target circuit;
a fourth input terminal configured to receive a second voltage level of a second end of the target circuit; and
an output terminal, wherein the error amplifier circuit is configured to generate the gate voltage based on the first reference voltage level, the second reference voltage level, the first voltage level, and the second voltage level, and to output the gate voltage at the output terminal, and
wherein a potential difference between the first voltage level and the second voltage level is an operating voltage of the target circuit.

2. The voltage regulator of claim 1, wherein the operating voltage of the target circuit is smaller than the output voltage.

3. The voltage regulator of claim 1, wherein a potential difference between the first reference voltage level and the second reference voltage level is a reference voltage.

4. The voltage regulator of claim 3, wherein the operating voltage matches the reference voltage.

5. The voltage regulator of claim 1, wherein the error amplifier circuit is configured to:
sum the first reference voltage level and the first voltage level, to obtain a first signal;
sum the second reference voltage level and the second voltage level, to obtain a second signal;
compare the first signal and the second signal, to obtain a comparison result; and
generate the gate voltage based on the comparison result.

6. The voltage regulator of claim 1, further comprising:
a header transistor connected between the at least one pass transistor and the first end of the target circuit and configured to operate in response to a first power gating voltage; and
a footer transistor connected between the second end of the target circuit and a ground node and configured to operate in response to a second power gating voltage.

7. The voltage regulator of claim 1, wherein the at least one pass transistor includes:
a first transistor connected between a first node and a second node and configured to operate in response to the gate voltage;
a second transistor including a gate connected to the second node and connected between the first node and a power node; and
a third transistor connected between the second node and a ground node and configured to operate in response to a bias voltage, and
wherein the first node and the target circuit are connected through a circuit line.

8. The voltage regulator of claim 1, wherein the at least one pass transistor includes a p-type metal-oxide-semiconductor field-effect-transistor connected to an output node and configured to operate in response to the gate voltage, and
wherein the output node is connected to the first end of the target circuit through a circuit line.

9. The voltage regulator of claim 1, wherein the error amplifier circuit includes:
a first transistor connected between a first node and a third node and configured to operate in response to the first reference voltage level;
a second transistor connected between a second node and a fourth node and configured to operate in response to the second reference voltage level;
a third transistor connected between the first node and a fifth node and configured to operate in response to the first voltage level;
a fourth transistor connected between the second node and a sixth node and configured to operate in response to the second voltage level;
a fifth transistor connected between a power node and the third node and configured to operate in response to a bias voltage;
a sixth transistor connected between the power node and the fourth node and configured to operate in response to the bias voltage;
a seventh transistor connected between the power node and the fifth node and configured to operate in response to the bias voltage;
an eighth transistor connected between the power node and the sixth node and configured to operate in response to the bias voltage; and
an output stage circuit configured to generate the gate voltage based on a first signal at the first node and a second signal at the second node.

10. The voltage regulator of claim 9, wherein the error amplifier circuit includes:
a first degeneration resistor connected between the third node and the sixth node; and
a second degeneration resistor connected between the fourth node and the fifth node.

11. The voltage regulator of claim 10, wherein a first resistance magnitude of the first degeneration resistor matches a second resistance magnitude of the second degeneration resistor.

12. A voltage regulator configured to generate an output voltage, comprising:
an error amplifier circuit configured to generate a gate voltage based on a first reference voltage level, a second reference voltage level, a first voltage level of a first end of a target circuit, and a second voltage level of a second end of the target circuit; and
at least one pass transistor configured to generate the output voltage in response to the gate voltage,
wherein the first end of the target circuit is connected to the pass transistor through a circuit line,
wherein a potential difference between the first reference voltage level and the second reference voltage level is a reference voltage, and
wherein a potential difference between the first voltage level and the second voltage level is an operating voltage of the target circuit.

13. The voltage regulator of claim 12, wherein the output voltage is greater than the operating voltage.

14. The voltage regulator of claim 12, wherein the operating voltage matches the reference voltage.

15. The voltage regulator of claim 12, further comprising:
a plurality of target circuits connected between an output node of the at least one pass transistor and a circuit ground,
a first switch circuit connected between first ends of the target circuits and the error amplifier circuit and configured to select one or more of the target circuits to be connected to the error amplifier circuit through the first switch circuit; and
a second switch circuit connected between second ends of the target circuits and the error amplifier circuit and configured to select one or more of the target circuits to be connected to the error amplifier circuit through the second switch circuit,
wherein a voltage level of a third node at which the error amplifier circuit and the first switch circuit are connected matches the first voltage level, and
wherein a voltage level of a fourth node where the error amplifier circuit and the second switch circuit are connected matches the second voltage level.

16. The voltage regulator of claim 12, further comprising:
a feedback circuit connected between the first end of the target circuit and the error amplifier circuit and configured to generate a third voltage level based on the first voltage level and to provide the third voltage level to the error amplifier circuit,
wherein the error amplifier circuit is configured to generate the gate voltage based on the third voltage level, and
wherein the operating voltage of the target circuit is greater than a potential difference between the third voltage level and the second voltage level.

17. The voltage regulator of claim 16, wherein the feedback circuit includes:
a first resistor connected between (i) a feedback node connected to the error amplifier circuit and (ii) a ground node; and
a second resistor connected between the feedback node and the first end of the target circuit.

18. An electronic system comprising:
a plurality of electronic devices; and
a power management integrated circuit including a voltage regulator configured to provide an output voltage to the plurality of electronic devices,
wherein the voltage regulator includes:
an error amplifier circuit configured to generate a gate voltage based on
a first voltage level of a first node connected to a first end of target circuits included in each of the plurality of electronic devices, the first ends of the target circuits being provided with an operating current,
a second voltage level of a second node connected to second ends of the target circuits,
a first reference voltage level, and
a second reference voltage level.

19. The electronic system of claim 18, wherein the error amplifier circuit is configured to:
sum the first reference voltage level and the first voltage level, to obtain a first signal;
sum the second reference voltage level and the second voltage level, to obtain a second signal;
compare the first signal and the second signal to obtain a comparison result; and
generate the gate voltage based on the comparison result.

20. The electronic system of claim 19, wherein the voltage regulator includes:
a pass transistor configured to generate the output voltage based on the gate voltage.
